(19) United States
(12) Patent Application Publication
(10) Pub. No.: US 2003/0141609 A1
(43) Pub. Date: Jul. 31, 2003

(54) Method for momentarily heating the surface of a mold and system thereof

(76) Inventor: Yim Sook Jia, Seoul (KR)

Correspondence Address: ABELMAN, FRAYNE & SCHWAB, Attorneys at Law, 150 East 42nd Street, New York, NY, 10017, US

(21) Appl. No.: 10/024,743

(22) Filed: Dec. 19, 2001

Related U.S. Application Data
(63) Continuation-in-part of application No. 09/694,409, filed on Oct. 23, 2000.

(30) Foreign Application Priority Data
Jan. 13, 2000 (KR) 2000-1521
May 29, 2000 (KR) 2000-29088
Aug. 24, 2000 (KR) 2000-49277
Sep. 22, 2000 (KR) 2000-55868

(51) Int. Cl. B29C 33/40; B29C 45/73

(52) U.S. Cl. 264/39; 264/334; 264/328.14; 264/328.16; 264/404; 425/144; 425/548; 249/79

(57) ABSTRACT

Disclosed herein is a system for momentarily heating the surface of a mold and system thereof. The system comprises a casting material feeder, upper and lower molds, a water-cooled system, first and second cores, a voltage generator, a electric resistance heater, a controller, an injection molding control, an air and gaseous fuel mixture and supply unit, an interface and a control panel. The casting material feeder serves to supply molten casting material. The injection molding control serves to control the upper mold and the lower mold. The air and gaseous fuel mixture and supply unit serves to supply compressed air and gaseous fuel simultaneously. The gaseous fuel mixture and supply control serves to control the operation of the air and gaseous fuel mixture and supply unit. The interface serves to interface the injection molding control and the gaseous fuel mixture and supply control. The control panel serves to visually display the control, condition and operation of the components of the system. The water-cooled system serves to cool the surface of a heated mold. The electric resistance heater serves to heat the first core.

### CROSS-REFERENCE TO RELATED APPLICATION

This application is a continuation-in-part of U.S. patent application Ser. No. 09/694,409 filed Oct. 23, 2000. The above-identified application is incorporated herein by reference for all purposes.

### BACKGROUND OF THE INVENTION

1. Field of the Invention

The present invention relates generally to methods for momentarily heating the surface of a mold and system thereof, and particularly to a method for momentarily heating the surface of a mold and system thereof, which is capable of momentarily heating the surface of the mold prior to injection molding and cooling a molded product immediately after the molding, thereby improving the quality of products in appearance, preserving the physical and thermal properties of resin in the products, and increasing the productivity of a manufacturing process of the products for the reduction of the manufacturing cost of the products.

2. Description of the Prior Art

In a technical field where resin (such as synthetic resin, plastics or the like) products are manufactured, various attempts have been made to momentarily heat a mold to the same temperature as that of resin while the cavity of the mold is being filled with the resin, and to rapidly cool the mold after the cavity of the mold is filled with the resin. The object of these attempts is to increase the quality of products in appearance, to improve the strength and thermal properties of the products and to increase the productivity of the manufacturing process of the products for the reduction of the manufacturing costs of the products.

German Pat. Appln. No. 297 08 721.5 and PCT Appln. No. WO 98/51460 disclose a mold capable of being temporarily heated by the flame of gaseous fuel and synthetic resin forming method thereof According to the above described patents, a synthetic resin injecting mold process is automated and the molded products of synthetic resin may be manufactured continuously.

However, according to the above-described patents, since a molded product cannot be cooled immediately after the forming of the product, the quality of the molded product is reduced in appearance, the strength and thermal properties of the injection-molded product are deteriorated and the productivity of the molding process is reduced.

### SUMMARY OF THE INVENTION

Accordingly, the present invention has been made keeping in mind the above problems occurring in the prior art, and an object of the present invention is to provide a method for momentarily heating the surface of a mold, which allows the mold to be filled with molten resin for injection molding after the preheating of the mold to a predetermined temperature and allows an injection-molded product to be cooled upon the completion of the injection molding, thereby increasing the quality of the injection-molded product in appearance and improving the strength and thermal properties of the injection-molded product.

Another object of the present invention is to provide a system for momentarily heating the surface of a mold, which comprises upper and lower molds for forming resin and performing the heating of the upper and lower molds, a supply unit for supplying air and gaseous fuel, a safety unit for preventing the danger of gas explosion, and a control unit for controlling the operation of the above components.

A further object of the present invention is to provide a method for momentarily heating the surface of a mold and system thereof, in which one or more cores are disposed between its upper and lower molds, the cores are momentarily heated using gaseous fuel or an induction heater, and heating and cooling are performed in the process of injection molding, thereby improving the quality of an injection-molded product. Heating of the mold surface may also be performed by laser, microwave, radiant, resistive, impingement (i.e., high velocity gas), piezoelectric or any other suitable heating technique that can heat the mold surface quickly. Another method of heating the mold surface is alternating or staged or pulsed between upper and lower molds or external and internal molds.

In order to accomplish the above objective, the present invention provides a method for momentarily heating a surface of a mold, comprising the steps of: opening upper and lower molds and first and second cores of the mold, and supplying gaseous fuel; injecting and igniting the gaseous fuel from the upper and lower molds after allowing the upper and lower molds to come close to each other at a predetermined distance; heating the core for a predetermined time period; filling a forming space between the upper and lower molds with molten material through the upper mold, immediately after stopping heating, closing the upper and lower molds and the core and allowing the molded product to cool for a predetermined time period; cooling the core and a molded product for a predetermined time period by spraying cooling water on the core and the molded product after allowing the upper and lower molds to be opened away from the core at predetermined distances; and ejecting the molded product from the upper and lower molds after allowing the upper and lower molds and the core to be completely opened.

In addition, the molded product may be cooled directly or indirectly in the mold by cooling channels in the mold, condensing of a vapor, water spray, or other suitable means of removing heat quickly.

In addition, the present invention provides a system for momentarily heating the surface of a mold, comprising: a casting material feeder for supplying molten casting material; upper and lower molds for forming a predetermined shaped cast; first and second cores disposed between the upper and lower molds; a water-cooled system for cooling a heated mold by injecting cooling water to the heated mold; an injection molding control for controlling the upper and lower molds; an air and gaseous fuel mixture and supply unit for supplying compressed air and gaseous fuel simultaneously; a gaseous fuel mixture and supply control for controlling the operation of the air and gaseous fuel mixture and supply unit; an interface for interfacing the injection molding control and the gaseous fuel mixture and supply control; and a control panel for visually displaying the control, condition and operation of the components of the system.

### BRIEF DESCRIPTION OF THE DRAWINGS

The above and other objectives, features and other advantages of the present invention will be more clearly understood from the following detailed description taken in conjunction with the accompanying drawings, in which:

FIG. 1 is a schematic diagram showing a water-cooled system for momentarily heating and cooling the surface of a mold in accordance with an embodiment of the present invention;

FIG. 2 is a schematic diagram showing a system for momentarily heating and cooling the surface of a mold in accordance with an embodiment of the present invention;

FIG. 3 is a schematic diagram showing a system for momentarily heating and cooling the surface of a mold in accordance with an embodiment of the present invention,

FIG. 4 is a detailed view of the core shown in FIG. 3; and

FIG. 5 is a block diagram illustrating the control panel of the system for momentarily heating the surface of a mold.

### DESCRIPTION OF THE PREFERRED EMBODIMENTS

Reference now should be made to the drawings, in which the same reference numerals are used throughout the different drawings to designate the same or similar components.

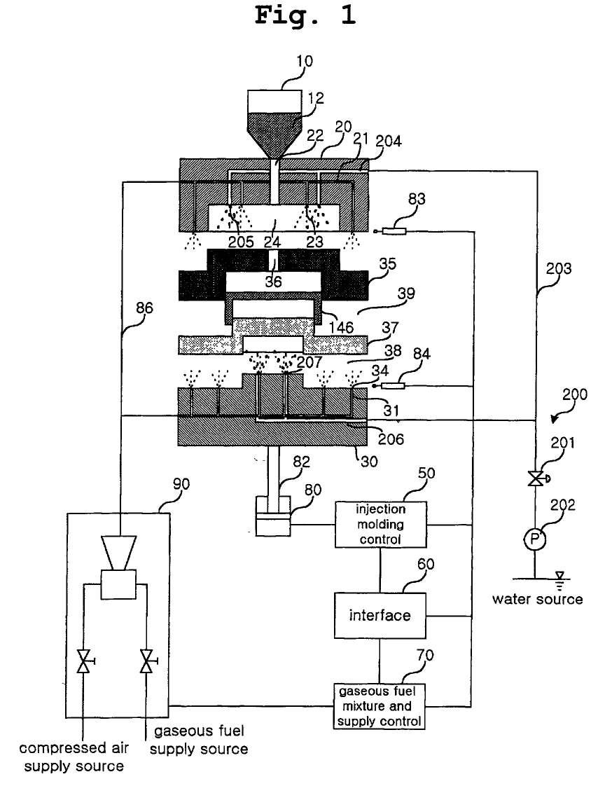

FIG. 1 is a schematic diagram showing a water-cooled system for momentarily heating and cooling the heated surface of a mold in accordance with an embodiment of the present invention. That is, there is shown the water-cooled system that cools a heated mold by injecting cooling water to the heated mold.

Reference numeral 10 designates a casting material feeder for supplying molten casting material. The casting material feeder 10 supplies injectable material, such as synthetic resin or metal.

An upper mold 20 is fixed to the lower end of the casting material feeder 10 under the casting material feeder 10. The upper mold 20 has a casting material supply hole 22 for supplying casting material from the casting material feeder 10 to the upper mold 20, a upper mold supply conduit 21 for supplying mixed gaseous fuel, said upper mold supply conduit 21 being formed in the upper mold 20, a plurality of upper mold discharge holes 23 for heating the core using the mixed gaseous fuel supplied through the upper mold supply conduit 21. The upper mold 20 is provided with a limit switch 83 for sensing the position of the upper mold 20.

A lower mold 30 is disposed under the upper mold 20. The lower mold 30 comprises a lower mold supply conduit 31 formed in the lower mold 30 to supply mixed gaseous fuel, a plurality of discharge holes 34 for heating the second core 37 using the mixed gaseous fuel supplied through the lower mold supply conduit 31, a limit switch 84 for sensing the position of the lower mold 30, an air and gaseous fuel mixture and supply unit 90 for supplying air or mixed gaseous fuel supplied through an air and mixed gaseous fuel supply conduit 86, and an elevating cylinder 80 including an elevating shaft 82 for selectively lifting or lowering the lower mold 30 by the control of an injection molding control 50. The discharge holes 34 are constructed in the form of slits, respectively having widths of 0.01 to 0.1 mm, and are distributed on the surface of the lower mold 30 in accordance with the shape of the cast.

Although not depicted in the drawing, an ignition unit for igniting gaseous fuel injected by an igniter using high voltage current generated by a high voltage generator and sensing gaseous fuel flame by means of a flame sensor.

The injection molding control 50 controls the upper and lower molds 20 and 30. In detail, the injection molding control 50 controls the mechanical operation for an injection molding process.

The air and gaseous fuel mixture and supply unit 90 serves to supply air and gaseous fuel, and comprises a variety of pipelines for supplying air and gaseous fuel and a variety of valves and gauges for controlling the flow of air and gaseous fuel.

A gaseous fuel mixture and supply control 70 serves to control the operation of the air and gaseous fuel mixture and supply unit 90. The gaseous fuel mixture and supply control 70 is connected to the injection molding control 50 through an interface 60, and receives signals from and transmits signals to the injection molding control 50. The gaseous fuel mixture and supply control 70 includes a microprocessor.

The water-cooled system 200 comprises, cooling water passages 204 and 206 are arranged through upper and lower molds 20 and 30, a cooling water supply conduit 203 is connected to the cooling water passages 204 and 206, an electronic valve 201 is positioned on the cooling water supply conduit 203 to selectively open or close the cooling water supply conduit 203, and a motor pump 202 is positioned on the cooling water supply conduit 203 to supply cooling water through the cooling water supply conduit 203.

Hereinafter, a method for momentarily heating and cooling the surface of a mold using the flame of gaseous fuel is described with reference to FIG. 1.

Molds and cores are heated using air and gaseous fuel mixture supplied by the air and gaseous fuel mixture and supply unit 90. After the molds and the cores have been heated, the upper and lower molds 20 and 30 and the first and second cores 35 and 37 are closed and molten material is injected into the mold. Thereafter, the upper and lower molds 20 and 30 are allowed to be opened away from the first and second cores 35 and 37 at predetermined distances (for example, 1 to 400 mm). When the upper and lower molds 20 and 30 have been opened, the electronic valve 201 is opened and the motor 202 is operated by the control of the controller 72. Consequently, cooling water is supplied to the upper and lower molds 20 and 30 through the cooling water supply conduit 203, so the cooling water is injected to the first and second cores 35 and 37 through the supply holes 205 and 207 of the cooling water passages 204 and 206 and cools the first and second cores 35 and 37. In this case, a time period for cooling a molded product 146 is, for example, in the range of 5 to 300 seconds. The system of this embodiment may be applied to a case where cooling faster than cooling using compressed air is required.

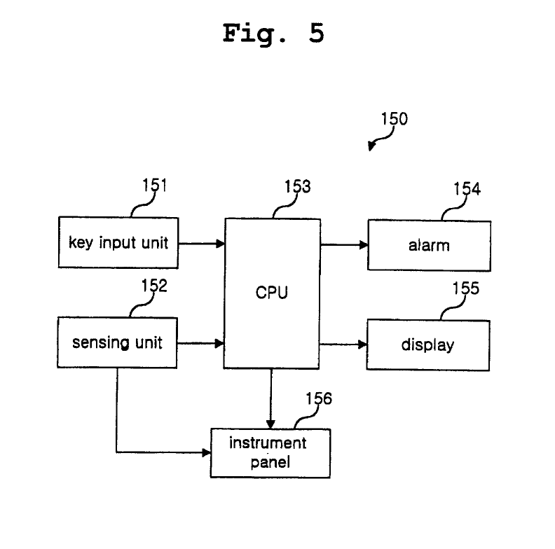

The heating system of the present invention includes a control panel for controlling the components of the system and inputting the operational conditions of the components. The control panel is illustrated as a block diagram in FIG. 5.

The control panel includes a key input unit 151, a sensing unit 152, a Central Processing Unit (CPU) 153, an alarm 154, a display 155 and an instrument panel 156.

The key input unit 151 has a plurality of keys, and serves to input various operational conditions for injection molding.

The sensing unit 152 serves to sense the various states of the system, convert a sensing signal to an electric signal and output the electric signal. The states include the elevation of the dies, the pressures and amounts of air and gaseous fuel, the leakage of gas and the like.

The CPU 153 serves to perform determination on the basis on an input signal and to output a control signal. The CPU 153 can be included in the injection molding control 50 and the gaseous fuel mixture and supply control 70.

The alarm 154 serves to warn of system error and danger situations. The alarm 154 may be activated when gas leaks or pressure variations outside predetermined limits occur.

The display 155 serves to indicate the information of the operation of the system. A user can monitor the operation of the system using the display 155.

The instrument panel 156 serves to indicate the operation of various components of the system. The instrument panel 156 may indicate the pressures of air and gaseous fuel and the state of safety.

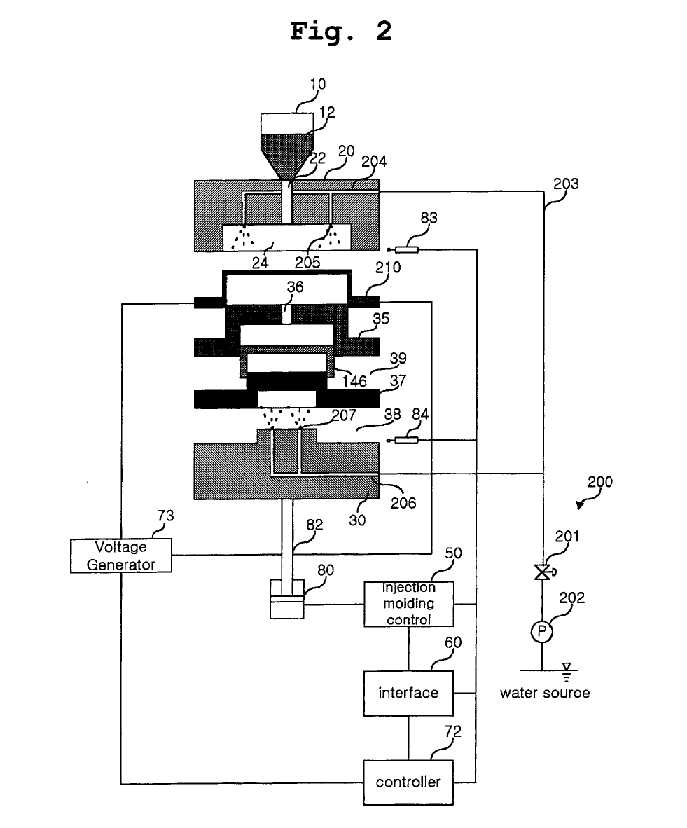

FIG. 2 shows a system for momentary heating the surface of a mold, in which the surface of the mold is cooled using cooling water in the same manner as that of the embodiment shown in FIG. 1, while the surface of the mold is heated by a variable electric resistance heater.

In the meantime, when the variable electric resistance heater 210 is employed, the injection molding control 50 and interface 60 for controlling the components of the system and a controller 72 for transmitting and receiving control signals are included in the system. The controller 72 includes a control program.

A variable electric resistance heater 210 is positioned between the upper mold 20 and the first core 35, and generates heat by its own electric resistance using a voltage supplied from a voltage generator 73.

In the system shown in FIG. 2, an upper mold 20 and a first core 35 are heated by the electric resistance heater 210 for a predetermined time period, for example, about 1 to 300 seconds.

After the upper mold 20 and the first core 35 are heated, the upper and lower molds 20 and 30 and the first and second cores 35 and 37 are closed and molten material is injected into the mold. Thereafter, the upper and lower molds 20 and 30 are allowed to be opened away from the first and second cores 35 and 37 at predetermined distances (for example, 1 to 400 mm). Additionally, it is desirable to keep a predetermined distance between the upper mold 20 and the electric resistance heater 210, for example, in the range of 0.1 to 30 mm.

At this time, when the upper and lower molds 20 and 30 have been opened, the electronic valve 201 is opened and the motor 202 is operated by the control of the controller 72. Consequently, cooling water is supplied to the upper and lower molds 20 and 30 through the cooling water supply conduit 203, so the cooling water is sprayed on the first and second cores 35 and 37 through the supply holes 205 and 207 of cooling water passages 204 and 206 and cools the first and second cores 35 and 37. In this case, a time period for cooling a molded product 146 is, for example, in the range of 5 to 300 seconds.

In the system for momentarily heating the surface of a mold shown in FIG. 2, the molds and the cores are heated by the variable electric resistance heater 210 instead of air and fuel gaseous mixture and the surface of the molds and the cores are cooled by cooling water. The system of this embodiment may be applied to a case where cooling faster than cooling using compressed air is required. While cooling water is sprayed, a voltage is not supplied to the electric resistance heater 210.

The variable electric resistance heater 210 can be inserted not only between the upper mold 20 and the first core 35 but also between the lower mold 30 and the second core 37. Additionally, the variable electric resistance heater 210 can be inserted between the upper mold 20 and the first core 35 and/or between the second mold 30 and the second core 37. The variable electric resistance heater 210 is preferably made of silicon line material having superior resistance.

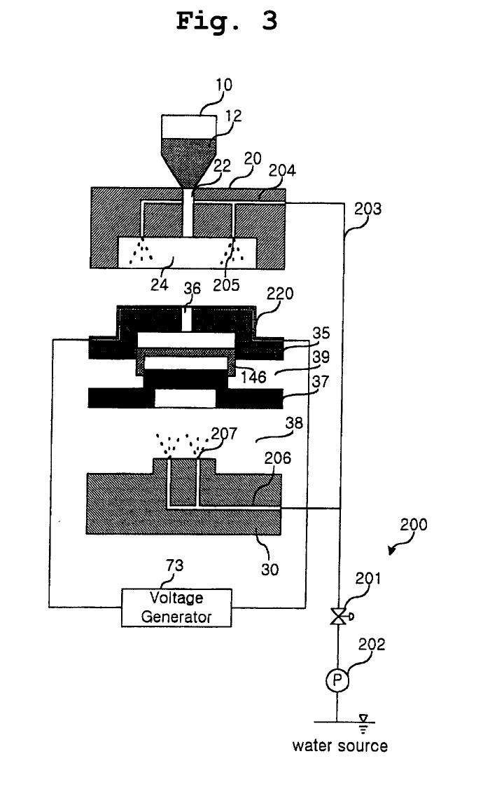

In an embodiment shown in FIG. 3, the molds and the cores are cooled in the same water-cooled manner as that for the embodiments shown in FIGS. 1 and 2, while the molds and the cores are heated by a coating type electric resistance heater.

The system for momentarily heating the surface of a mold is similar in construction to the system shown in FIG. 2, but the surface is coated with a coating type electric resistance heater 220 is formed on the upper surface of the first core 35. The coating type electric resistance heater 220 generates heat by its own electric resistance using a certain voltage supplied from a voltage generator 73.

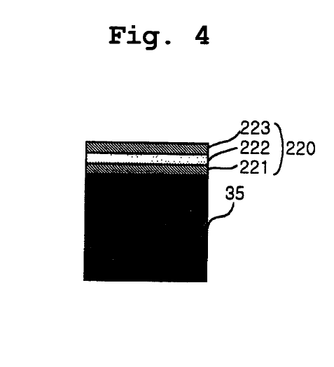

As shown in FIG. 4, the coat of the electric resistance heater 220 is formed by coating the upper surface of the core 35 primarily with a first insulating layer 221, coating the first insulating layer 221 with an electric resistance layer 222 and coating the electric resistance layer 222 secondarily with a second insulating layer 223. The first insulating layer 221 is to insulate the electric resistance layer 222 from the core 35, and the second insulating layer 223 is to insulate the electric resistance layer 222 from the upper mold 20. The electric resistance layer 222 and a plurality of insulating layers 221 and 223 are stacked together with one on top of another, so the amount of heat applied to the layers can be controlled.

The insulating layers 221 and 223 and the electric resistance layer 222 each have a thickness ranging from 0.01 to 10 mm. The insulating layers 221 and 223 are preferably formed of MgO+Teflon having insulation and heat-resistance characteristics, while the electric resistant layer 222 is preferably formed of conductive metal or thermopolymer line material having superior electric resistance.

In the system shown in FIG. 3, the first core 35 is heated by the electric resistance heater 220 for a predetermined time period (for example, about 1 to 300 seconds).

At this time, when the upper and lower molds 20 and 30 have been opened, an electronic valve 201 is opened and a motor 202 is operated by the control of a controller 72. Consequently, cooling water is supplied to the upper and lower molds 20 and 30 through a cooling water supply conduit 203, so the cooling water is sprayed on the first and second cores 35 and 37 through the supply holes 205 and 207 of cooling water passages 204 and 206 and cools the first and second cores 35 and 37. In this case, a time period for cooling a molded product 146 is, for example, in the range of 5 to 300 seconds.

In the system for momentary heating the surface of a mold shown in FIG. 3, the molds and the cores are heated by the coating type electric resistance heater 210 instead of an air and fuel gaseous mixture, and are cooled using cooling water. The system of this embodiment may be applied to a case where cooling faster than cooling using compressed air is required. While cooling water is sprayed, a voltage is not supplied from a voltage generator 73 to the coating type electric resistance heater 220.

The coating type electric resistance heater 220 may be formed on the upper surface of the first core 35 or the lower surface of the second core 37. In accordance with products, the coating type electric resistance heater 220 may be formed on the upper surface of the first core 35 and/or the lower surface of the second core 37, and may heat the cores.

All thermoplastic polymers can be injection molded according to the present invention. Suitable polymers for use in the present invention include those from group consisting of alkylene aromatic polymers such as polystyrene; rubber-modified alkylene aromatic polymers or copolymers, more commonly known as high impact polystyrene (HIPS) or ABS, alkylene aromatic copolymers such as styrene/acrylonitrile or styrene/butadiene; hydrogenated alkylene aromatic polymers and copolymers such as hydrogenated polystyrene and hydrogenated styrene/butadiene copolymers; alpha-olefin homopolymers such as low density polyethylene, high density polyethylene and polypropylene; linear low density polyethylene (an ethylene/octene-1 copolymer) and other copolymers of ethylene with a copolymerizable, mono-ethylenically unsaturated monomer such as an alpha-olefin having from 3 to 20 carbon atoms; copolymers of propylene with a copolymerizable, mono-ethylenically unsaturated monomer such as an alpha-olefin having from 4 to 20 carbon atoms, copolymers of ethylene with a vinyl aromatic monomer, such as ethylene/styrene interpolymers; ethylene/propylene copolymers; copolymers of ethylene with an alkane such as an ethylene/hexane copolymer; thermoplastic polyurethanes (TPU's); and blends or mixtures thereof, especially blends of polystyrene and an ethylene/styrene interpolymer.

Other suitable polymers include polyvinyl chloride, polycarbonates, polyamides, polyimides, polyesters such as polyethylene terephthalate, polyester copolymers such as polyethylene terephthalate-glycol (PETG), phenol-formaldehyde resins, thermoplastic polyurethanes (TPUs), biodegradable polysaccharides such as starch, and polylactic acid polymers and copolymers.

Certain blends and alloys of these polymers can also be injection molded in accordance with the teachings of the present invention.

The polymers listed above, together with alloys and blends made therefrom, can optionally contain mold release agents, fillers (such as glass fibers, stainless steel fibers, nickel-coated graphite fibers, carbon fibers, nanocomposite clay particles, metallic particles, talc, and the like), pigments, colorants, flame retardants, antioxidants and other additives.

The present invention can also be employed effectively with generally well known fabrication techniques, which can be used alone or in combination, such as foam molding, blow molding, thermoforming, extrusion, SCORIM, gas-assisted injection molding, co-injection, in-mold lamination, and like.

In connection with foam molding and related processes involving expanded thermoplastic or thermoset polymers disclosed herein, certain chemical blowing agents (such azodicarbonamide, sodium bicarbonate, and the like) and/or physical blowing agents (such as CO₂,N₂, steam, and like.) can also be used.

In addition to thermoplastics, this process is considered suitable for thermosetting resin materials formed by molding techniques generally referred to as reaction injection molding (RIM) or resin transfer molding RTM). Examples of thermosetting resin materials include epoxies, urethanes, acrylates, and vinyl esters.

Rapid heating of the mold is desirable for rapid polymerization of thermosets. The large heat of polymerization encountered with materials such as epoxies can be effectively managed by rapidly heating the mold selectively, thereby allowing for a large thermal mass to absorb the heat of polymerization.

The teachings of the present invention can also be used with a group of high density foams having microcellular closed cell structures disclosed in U.S. Pat. Nos. 4,473,665, 5,674,916 and 5,869,544 teachings of which are incorporated herein by reference.

The operable mold surface temperature ranges from the applicable melting point (m.p.) or glass transition temperature (Tg), as the case may be, depending, on the polymeric material being processed, to 300° C. above the relevant m.p. or Tg, preferably 200° C., more preferably 150° C., most preferably 100° C.

The method and system of the present invention is not limited to the injection molding of synthetic resin products, but the method and system can be applied to reactive injection molding, metallic cast forming and ceramic forming and the like.

As described above, the present invention provides a method for momentarily heating the surface of a mold and system thereof, which is capable of improving the quality of products in appearance, preserving the physical and thermal properties of resin in the products, increasing the productivity of the manufacturing process of the products and reducing the manufacturing cost of the products.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for momentarily heating a surface of a mold, comprising the steps of:
opening upper and lower molds and first and second cores of the mold, and supplying gaseous fuel;
injecting and igniting the gaseous fuel from the upper and lower molds after allowing the upper and lower molds to come close to each other at a predetermined distance;
heating the core for a predetermined time period;
filling a forming space between the upper and lower molds with molten material through the upper mold, immediately after stopping heating, closing the upper and lower molds and the core and allowing the molded product to cool for a predetermined time period;
cooling the core and a molded product for a predetermined time period by spraying cooling water on the core and the molded product after allowing the upper and lower molds to be opened away from the core at predetermined distances; and
ejecting the molded product from the upper and lower molds after allowing the upper and lower molds and the core to be completely opened.

2. The method according to claim 1, wherein said predetermined time period for which the core is heated is in a range of 1 to 60 seconds, said predetermined distances between the upper mold and the first core, between the first and second cores and between the second core and the lower mold while the core is heated are in a range of 1 to 40 cm, said predetermined time period for which the core and the molded product are cooled in the closed mold is in a range of 5 to 300 seconds, said predetermined time period for which the core and the molded product are cooled by cooling water is in the range of 5 to 30 seconds and said predetermined distances between the upper mold and the first core and between the second core and the lower mold while the core and the molded product are cooled by the cooling water are in a range of 1 to 400 mm.

3. A method for momentarily heating the surface of a mold, comprising the steps of:
momentarily heating upper and lower molds by a variable electric resistance heater using current generated by a voltage generator after causing the upper and lower molds to come close to each other;
injecting molten casting material from a casting material feeder and molding it after raising the heated lower mold to and engaging the heated lower mold with the upper mold and allowing the molded product to cool in the close mold;
supplying compressed air from a compressed air supply line to the upper and lower molds through a compressed air supply line to cool a molded product; and
ejecting the molded product after cooling the molded product sufficiently.

4. The method according to claim 3, wherein said predetermined time period for which the upper mold and the core are heated is in a range of 1 to 60 seconds, said predetermined distances between the upper mold and the first core, between the first and second cores and between the second core and the lower mold while the core is heated are in a range of 1 to 40 cm, said predetermined distance between the mold and the voltage generator is in a range of 0.1 to 30 mm, said predetermined time period for which the core and the molded product are cooled by the cooling water is in a range of 5 to 300 seconds, and said predetermined distances between the upper mold and the first core and between the second core and the lower mold while the core and the molded product are cooled by the cooling water are in a range of 1 to 400 mm.

5. A method for momentarily heating the surface of a mold, comprising the steps of:
momentarily heating upper and lower molds by a coating type electric resistance heater using current generated by a voltage generator after causing the upper and lower molds to come close to each other,
injecting molten casting material from a casting material feeder and molding it after raising the heated lower mold to and engaging the heated lower mold with the upper mold and allowing the molded product to cool in the close mold;
supplying compressed air from a compressed air supply line to the upper and lower molds through a compressed air supply line to cool a molded product; and
ejecting the molded product after cooling the molded product sufficiently.

6. The method according to claim 5, wherein said predetermined time period for which the upper mold and the core are heated is in a range of 1 to 60 seconds, said predetermined distances between the upper mold and the first core, between the first and second cores and between the second core and the lower mold while the core is heated are in a range of 1 to 40 cm, said predetermined time period for which the core and the molded product are cooled by the cooling water is in a range of 5 to 300 seconds, and said predetermined distances between the upper mold and the first core and between the second core and the lower mold while the core and the molded product are cooled by the cooling water are in a range of 1 to 400 mm.

7. A product fabricated by the method according to claim 1.

8. A product fabricated by the method according to claim 2.

9. A product fabricated by the method according to claim 3.

10. A product fabricated by the method according to claim 4.

11. A product fabricated by the method according to claim 5.

12. A product fabricated by the method according to claim 6.

13. A system for momentarily heating the surface of a mold, comprising:
a casting material feeder for supplying molten casting material;
upper and lower molds for forming a predetermined shaped cast;
first and second cores disposed between the upper and lower molds;
a water-cooled system for cooling a heated mold by injecting cooling water to the heated mold;
an injection molding control for controlling the upper and lower molds;
an air and gaseous fuel mixture and supply unit for supplying compressed air and gaseous fuel simultaneously;
a gaseous fuel mixture and supply control for controlling the operation of the air and gaseous fuel mixture and supply unit;
an interface for interfacing the injection molding control and the gaseous fuel mixture and supply control; and
a control panel for visually displaying the control, condition and operation of the components of the system.

14. The system according to claim 13, further comprising,
a gaseous fuel supply conduit for supplying to upper and lower molds air or mixed gaseous fuel supplied through an air and gaseous fuel mixture and supply unit, and
a plurality of conduits for supplying an air and gaseous fuel mixture through the upper and lower molds.

15. A system for momentarily heating the surface of a mold, comprising:
a casting material feeder for supplying molten casting material;
upper and lower molds for forming a predetermined shaped cast;
first and second cores disposed between the upper and lower molds;
a water-cooled system for cooling a heated mold by injecting cooling water to the heated mold;
an injection molding control for controlling the upper and lower molds;
a voltage generator for generating voltage of a predetermined level;
a variable electric resistance heater for heating the cores using current applied from the voltage generator, said a variable electric resistance heater being disposed between the upper mold and the first core;
a controller for controlling the compressed air supply line and the voltage generator;
an interface for interfacing the injection molding control and the gaseous fuel mixture and supply control; and
a control panel for visually displaying the control, condition and operation of the components of the system.

16. A system for momentarily heating the surface of a mold, comprising:
a casting material feeder for supplying molten casting material;
upper and lower molds for forming a predetermined shaped cast;
first and second cores disposed between the upper and lower molds;
a water-cooled system for cooling a heated mold by injecting cooling water to the heated mold;
an injection molding control for controlling the upper and lower molds;
a voltage generator for generating voltage of a predetermined level;
a electric resistance heater for heating the cores using current applied from the voltage generator, said a electric resistance heater being coated on the first core;
a controller for controlling the compressed air supply line and the voltage generator;
an interface for interfacing the injection molding control and the gaseous fuel mixture and supply control; and
a control panel for visually displaying the control, condition and operation of the components of the system.

17. The system according to any of claims 13, 15, 16, wherein said water-cooled system comprises,
cooling water passages are arranged through upper and lower molds, a cooling water supply conduit is connected to the cooling water passages, an electronic valve is positioned on the cooling water supply conduit to selectively open or close the cooling water supply conduit, and a motor pump is positioned on the cooling water supply conduit to supply cooling water through the cooling water supply conduit.

18. The system according to claim 16, wherein said coat of the electric resistance heater is formed by coating the upper surface of the first core primarily with a first insulating layer, coating the first insulating layer with an electric resistance layer and coating the electric resistance layer secondarily with a second insulating layer.

19. A product fabricated by the system according to claim 13.

20. A product fabricated by the system according to claim 14.

21. A product fabricated by the system according to claim 15.

22. A product fabricated by the system according to claim 16.

23. A product fabricated by the system according to claim 17.

24. A product fabricated by the system according to claim 18.
